(19) United States
(12) Patent Application Publication
(10) Pub. No.: US 2024/0405272 A1
(43) Pub. Date: Dec. 5, 2024

(54) ELECTROLYTES COMPRISING FLUOROALKOXYSILANE ADDITIVES FOR LITHIUM ION BATTERIES INCLUDING SILICON-CONTAINING NEGATIVE

(71) Applicant: GM GLOBAL TECHNOLOGY OPERATIONS LLC, Detroit, MI (US)

(72) Inventors: Chuanlong WANG, Troy, MI (US); Xiaosong HUANG, Novi, MI (US)

(21) Appl. No.: 18/329,190

(22) Filed: Jun. 5, 2023

(51) Int. Cl. H01M 10/0567; H01M 10/0525; H01M 10/0569; H01M 10/42

(52) U.S. Cl. CPC H01M 10/0567; H01M 10/0525; H01M 10/0569; H01M 10/4235; H01M 2300/0037

(57) ABSTRACT

A battery that cycles lithium ions includes a positive electrode, a negative electrode, and an electrolyte infiltrating the positive electrode and the negative electrode. The negative electrode comprises a silicon-containing electroactive active material. The electrolyte includes an organic solvent, an inorganic lithium salt, and a fluoroalkoxysilane additive.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to additives for electrolytes of batteries that include silicon-containing negative electrodes to facilitate the formation of protective interphase layers on surfaces of the negative electrodes.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high dielectric constant (correlated with a high ability to dissolve salts), good thermal stability, a wide electrochemical stability window, ability to form a stable ionically conductive solid electrolyte interface (SEI) on the surface of the positive electrode and/or the negative electrode, and chemical compatibility with other components of the batteries.

### SUMMARY

A battery that cycles lithium ions comprises a positive electrode, a negative electrode, and an electrolyte infiltrating the positive electrode and the negative electrode. The negative electrode comprises a silicon-containing electroactive active material. The electrolyte comprises an organic solvent, an inorganic lithium salt in the organic solvent, and a fluoroalkoxysilane additive in the organic solvent.

The fluoroalkoxysilane additive may comprise a chemical compound having the following formula: X—Si(—OR¹)₃₋ₐ(R²)^{a}, where X is a fluoroalkyl group or a fluoroaryl group, R¹ and R² are each individually an alkyl group, and a is 1 or 2.

The fluoroalkoxysilane additive may comprise a polyfluoroaryl alkoxysilane, a polyfluoroalkyl alkoxysilane, or a combination thereof.

The fluoroalkoxysilane additive may comprise triethoxy (perfluorophenyl) silane, trimethoxy (3,3,3-trifluoropropyl) silane, 1H, 1H,2H,2H-perfluorooctyltriethoxysilane, 1H,1H,2H,2H-perfluorodecyltriethoxysilane, 1H, 1H,2H,2H-perfluorodecyltrimethoxysilane, dimethoxy(methyl) (3,3,3-trifluoropropyl) silane, or a combination thereof.

The fluoroalkoxysilane additive may have a lowest unoccupied molecular orbital (LUMO) of less than (more negative than) −0.25 electron volts and a highest occupied molecular orbital (HOMO) energy of more than (less negative than) −8 electron volts.

The fluoroalkoxysilane additive may constitute, by weight, greater than or equal to about 0.2% to less than or equal to about 1.8% of the electrolyte.

During cycling of the battery, the fluoroalkoxysilane additive may decompose and forms an interphase layer on surfaces of the silicon-containing electroactive active material of the negative electrode that isolates the silicon-containing electroactive active material from physical contact with the electrolyte.

The battery may further comprise an interphase layer formed in situ on the silicon-containing electroactive active material of the negative electrode during cycling of the battery. The interphase layer may comprise a hybrid organic-inorganic material and may physically isolates the silicon-containing electroactive active material from contact with the electrolyte.

The organic solvent may comprise ethylene carbonate and dimethyl carbonate.

The inorganic lithium salt may comprise lithium hexafluorophosphate.

A battery that cycles lithium ions comprises a positive electrode, a negative electrode, and an electrolyte infiltrating the positive electrode and the negative electrode. The positive electrode comprises a nickel-based electroactive material. The negative electrode comprises a silicon-containing electroactive active material. The electrolyte comprises an organic solvent, an inorganic lithium salt in the organic solvent, and a fluoroalkoxysilane additive in the organic solvent. The fluoroalkoxysilane additive comprises a chemical compound having the following formula: X—Si(—OR¹)₃₋ₐ(R²)^{a}, where X is a fluoroalkyl group or a fluoroaryl group, R¹ and R² are each individually an alkyl group, and a is 1 or 2.

The fluoroalkoxysilane additive may comprise triethoxy (perfluorophenyl) silane, trimethoxy (3,3,3-trifluoropropyl) silane, 1H, 1H,2H,2H-perfluorooctyltriethoxysilane, 1H,1H,2H,2H-perfluorodecyltriethoxysilane, 1H, 1H,2H,2H-perfluorodecyltrimethoxysilane, dimethoxy(methyl) (3,3,3-trifluoropropyl) silane, or a combination thereof.

The fluoroalkoxysilane additive may constitute, by weight, greater than or equal to about 0.2% to less than or equal to about 1.5% of the electrolyte.

The battery may further comprise a first interphase layer disposed on the nickel-based electroactive material of the positive electrode that physically isolates the nickel-based electroactive material from contact with the electrolyte and a second interphase layer disposed on the silicon-containing electroactive active material of the negative electrode that physically isolates the silicon-containing electroactive active material from contact with the electrolyte. The first interphase layer and the second interphase layer may be formed in situ during cycling of the battery. The first interphase layer and the second interphase layer may comprise decomposition products of the fluoroalkoxysilane additive.

Electrochemical oxidation of the fluoroalkoxysilane additive may occur at the positive electrode during charge of the battery. In such case, the first interphase layer may comprise byproducts of the electrochemical oxidation of the fluoroalkoxysilane additive.

Electrochemical reduction of the fluoroalkoxysilane additive may occur at the negative electrode during charge of the battery. In such case, the second interphase layer may comprise byproducts of the electrochemical reduction of the fluoroalkoxysilane additive.

The first interphase layer and the second interphase layer each may comprise a hybrid organic-inorganic material.

The first interphase layer and the second interphase layer each may comprise a chemical compound including silicon-oxygen bonds, silicon-carbon bonds, carbon-carbon bonds, carbon-hydrogen bonds, or a combination thereof.

The organic solvent may comprise ethylene carbonate and dimethyl carbonate. The inorganic lithium salt may comprise lithium hexafluorophosphate.

The nickel-based electroactive material may comprise lithium nickel cobalt manganese aluminum oxide, lithium nickel manganese cobalt oxide, lithium nickel cobalt aluminum oxide, or a combination thereof. The silicon-based electroactive material may comprise silicon, silicon oxide, lithium silicon oxide, or a combination thereof.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating pores of the positive and negative electrodes and the porous separator.

In the drawings, reference numbers may be reused to identify similar and/or identical elements.

### DETAILED DESCRIPTION

The presently disclosed electrolytes are formulated for use in lithium ion batteries that include negative electrodes comprising silicon-containing electroactive materials. The electrolytes comprise a fluoroalkoxysilane additive that is formulated to decompose during cycling of the batteries to form protective interphase layers on the silicon-containing electroactive materials of the negative electrodes. The protective interphase layer formed on the silicon-containing electroactive material of the negative electrode may isolate the silicon-containing electroactive active material from physical contact with the electrolyte, which may help improve the cycling stability and capacity retention of the battery, for example, by preventing undesirable chemical reactions from occurring between the silicon-containing electroactive active material and the electrolyte during cycling of the battery. In addition, the presently disclosed electrolytes may be used in lithium ion batteries that include positive electrodes comprising nickel-based electroactive materials. In such case, the fluoroalkoxysilane additive may decompose during cycling of the batteries to form a protective interphase layer on the nickel-based electroactive materials of the positive electrodes. The protective interphase layers respectively formed on the silicon-containing electroactive materials of the negative electrodes and the nickel-based electroactive materials of the positive electrodes may comprise hybrid organic-inorganic materials.

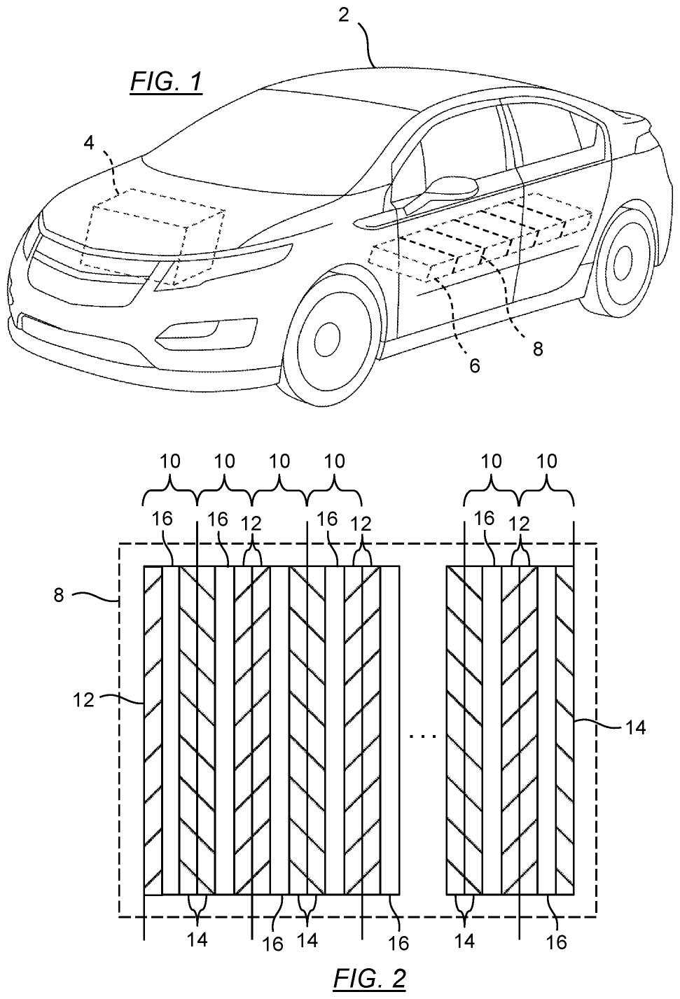

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

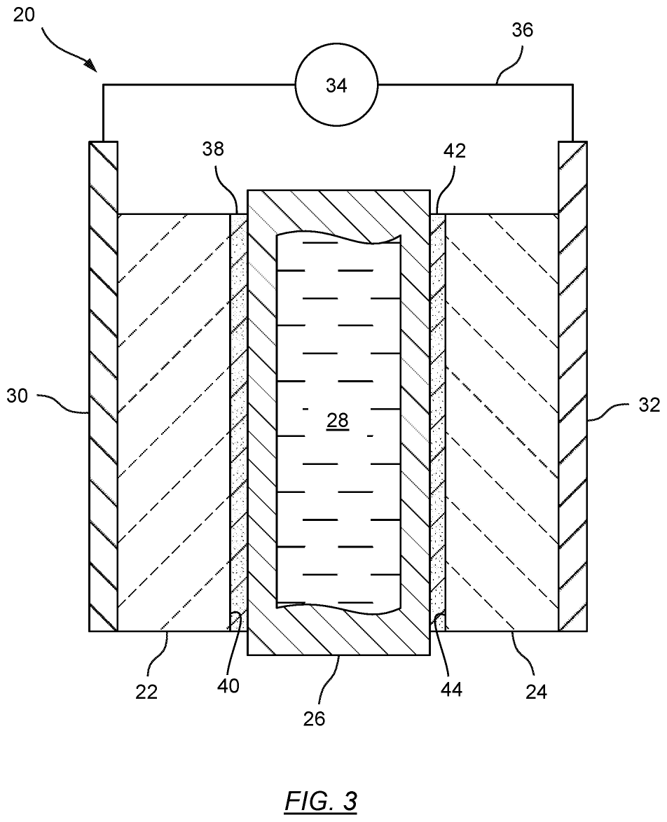

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that infiltrates the negative electrode 22, the positive electrode 24, and the separator 26. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous redox reactions within the battery 20 and the release of lithium ions and electrons at the negative electrode 22. The released lithium ions travel from the negative electrode 22 to the positive electrode 24 through the separator 26 and the electrolyte 28, and the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle. During initial charge of the battery 20, a first interphase layer 38 may form in situ on surfaces 40 of the negative electrode 22, along an interface between the negative electrode 22 and the separator 26, and a second interphase layer 42 may form in situ on surfaces 44 of the positive electrode 24, along an interface between the positive electrode 24 and the porous separator 26.

The negative electrode 22 is configured to store and release lithium ions during charge and discharge of the battery 20. The negative electrode 22 may be in the form of a continuous porous layer of material disposed on a major surface of the negative electrode current collector 30. The negative electrode 22 is configured to store and release lithium ions to facilitate charge and discharge, respectively, of the battery 20. To accomplish this, the negative electrode 22 includes one or more electrochemically active (electroactive) materials that can facilitate the storage and release of lithium ions by undergoing a reversible redox reaction with lithium during charge and discharge of the battery 20. The electroactive materials of the negative electrode 22 may constitute, by weight, greater than or equal to about 80%, optionally about 90%, optionally about 95% to less than or equal to about 99%, or optionally about 98% of the negative electrode 22.

At least one of the electroactive materials of the negative electrode 22 is a silicon-based material. As an electroactive material, silicon (Si) can facilitate the storage of lithium in the negative electrode 22 during charging of the battery 20 by forming an alloy with lithium (lithiation) and, during discharge of the battery 20, lithium ions can be released from the negative electrode 22 by dealloying from silicon (delithiation). The term “silicon-based,” as used herein with respect to the electroactive material of the negative electrode 22, broadly includes materials in which silicon is the single largest constituent on a weight percentage (%) basis. This may include materials having, by weight, greater than 50% silicon, as well as those having, by weight, less than 50% silicon, so long as silicon is the single largest constituent of the material. In aspects, the silicon-based electroactive material of the negative electrode 22 may comprise, by weight, greater than or equal to about 50%, optionally about 60%, optionally about 70%, optionally about 80%, or optionally about 90% silicon. Examples of silicon-based electroactive materials include silicon (Si), silicon oxide (SiOx), lithium silicon oxide (LiSiOx), lithium silicide (LixSi), and combinations thereof. In addition to the silicon-based electroactive material, the negative electrode 22 may comprise a carbon-based electroactive material (e.g., graphite), tin, tin oxide, aluminum, bismuth, antimony, indium, zinc, germanium, germanium oxide, titanium oxide, and/or lithium as an electroactive material.

In aspects, the negative electrode 22 may comprise a silicon-based electroactive material and a carbon-based electroactive material. For example, the electroactive material of the negative electrode 22 may comprise a composite of silicon and carbon (Si—C), a composite of silicon oxide and carbon (SiOₓ—C), or a combination thereof. In such case, the electroactive material of the negative electrode 22 may comprise, by weight, greater than or equal to about 1%, optionally about 5%, optionally about 10%, or optionally about 20% to less than or equal to about 90%, optionally about 50%, or optionally about 30% silicon. In aspects, the electroactive material of the negative electrode 22 may comprise, by weight, about 5.5% SiOx. The electroactive material of the negative electrode 22 may comprise, by weight, greater than or equal to about 10%, optionally about 20%, optionally about 40%, or optionally about 50% to less than or equal to about 95%, optionally about 90%, optionally about 80%, or optionally about 70% carbon (e.g., graphite). In aspects, the electroactive material of the negative electrode 22 may comprise, by weight, about 94.5% carbon (e.g., graphite).

The electroactive material of the negative electrode 22 may be a particulate material and particles of the electroactive material of the negative electrode 22 may be intermingled with a polymer binder, for example, to provide the negative electrode 22 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. In aspects, the negative electrode 22 may comprise a polymer binder comprising a mixture of carboxymethyl cellulose and styrene butadiene rubber.

The negative electrode 22 optionally may include particles of an electrically conductive material. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. In aspects, the negative electrode 22 may comprise an electrically conductive material comprising carbon black.

The positive electrode 24 is configured to store and release lithium ions during discharge and charge of the battery 20. The positive electrode 24 may be in the form of a continuous porous layer disposed on the major surface of the positive electrode current collector 20. The positive electrode 24 may include one or more electrochemically active (electroactive) materials that can undergo a reversible redox reaction with lithium at a higher electrochemical potential than the electroactive material of the negative electrode 22 such that an electrochemical potential difference exists between the positive and negative electrodes 12, 14. For example, the electroactive material of the positive electrode 24 may comprise a material that can undergo lithium intercalation and deintercalation or can undergo a conversion by reaction with lithium. In aspects, the electroactive material of the positive electrode 24 may comprise an intercalation host material that can undergo the reversible insertion or intercalation of lithium ions. In such case, the electroactive material of the positive electrode 24 may comprise a layered oxide represented by the formula LiMeO₂, an olivine-type oxide represented by the formula LiMePO₄, a monoclinic-type oxide represented by the formula LisMe₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof).

In aspects, the electroactive material of the positive electrode 24 may comprise a nickel-based material, meaning nickel (Ni) is the single largest constituent of the electroactive material on a weight percentage (%) basis. This may include electroactive materials having, by weight, greater than 50% nickel, as well as those having, by weight, less than 50% nickel, so long as nickel is the single largest constituent of the electroactive material based upon its overall weight. In aspects, the electroactive material of the positive electrode 24 may comprise, by weight, greater than or equal to about 50%, optionally about 60%, optionally about 70%, optionally about 80%, or optionally about 85% nickel. Examples of nickel-based electroactive materials include lithium nickel cobalt manganese aluminum oxide (NCMA), lithium nickel manganese cobalt oxide (NMC), lithium nickel manganese oxide (LNMO), e.g., LiNi_{0.5}Mn_{1.5}O₄ and/or Li_{1.2}Ni_{0.2}Mn_{0.6}O₂, lithium nickel cobalt aluminum oxide (NCA), and combinations thereof. In aspects, the electroactive material of the positive electrode 24 may comprise lithium manganese iron phosphate (LMFP), lithium iron phosphate (LFP), lithium manganese oxide (LMO), or a combination thereof.

The electroactive material of the positive electrode 24 may constitute, by weight, greater than or equal to about 80%, optionally about 90%, optionally about 95% to less than or equal to about 99%, or optionally about 98% of the positive electrode 24.

Like the electroactive material of the negative electrode 22, the electroactive material of the positive electrode 24 may be a particulate material and particles of the electroactive material of the positive electrode 24 may be intermingled with a polymer binder and/or particles of an electrically conductive material. The same polymer binders and/or electrically conductive materials disclosed above with respect to the negative electrode 22 may be used in the positive electrode 24. In aspects, the positive electrode 24 may comprise a polymer binder comprising polyvinylidene fluoride. In aspects, the positive electrode 24 may comprise an electrically conductive material comprising a mixture of carbon nanotubes, carbon black, and graphene nanoplatelets.

The separator 26 physically separates and electrically isolates the negative and positive electrodes 22, 24 from each other while permitting lithium ions to pass therethrough. The separator 26 exhibits an open microporous structure and may comprise an organic and/or inorganic material that can physically separate and electrically insulate the negative and positive electrodes 22, 24 from each other while permitting the free flow of ions therebetween. For example, the separator 26 may comprise a non-woven material, e.g., a manufactured sheet, web, or mat of directionally or randomly oriented fibers. As another example, the separator 26 may comprise a microporous membrane or film. The non-woven material and/or the microporous membrane of the separator 26 may comprise a polymeric material. For example, the separator 26 may comprise a polyolefin-based material having the general formula (CH₂CH_{R})ₙ, where R is an alkyl group. In aspects, the separator 26 may comprise a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the separator 26 include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene. In one form, the separator 26 may comprise a laminate of two, three, or more layers of microporous polymeric materials, e.g., a laminate of PP-PE or a laminate of PP-PE-PP. In one form, the separator 26 may comprise a nanofibrous sandwich structure of PVdF-PMIA-PVdF. In aspects, the separator 26 may include a ceramic coating layer and/or a heat-resistant material coating. The ceramic coating layer may comprise alumina (Al₂O₃) and/or silica (SiO₂). The heat-resistant material coating may comprise Nomex® and/or Aramid.

The electrolyte 28 is ionically conductive provides a medium for the conduction of lithium ions between the negative and positive electrodes 22, 24 and is formulated to provide the battery 20 with enhanced cycling stability. For example, the electrolyte 28 may be formulated to promote the formation of the first interphase layer 38 and/or the second interphase layer 42 during initial charge and cycling of the battery 20. The electrolyte 28 comprises an organic solvent, an inorganic lithium salt, a fluoroalkoxysilane additive, and optionally one or more carbonate additives.

The organic solvent may comprise a nonaqueous aprotic organic carbonate or a mixture of nonaqueous aprotic organic carbonates. In aspects, the organic solvent may comprise a mixture of a cyclic carbonate and a linear carbonate. Examples of cyclic carbonates include ethylene carbonate (EC), propylene carbonate (PC), and combinations thereof. Examples of linear carbonates include dimethyl carbonate (DMC), diethyl carbonate (DEC), ethyl methyl carbonate (EMC), and combinations thereof. The organic solvent may constitute, by weight, greater than or equal to about 70% to less than or equal to about 90% of the electrolyte 28. In aspects, the organic solvent may comprise a mixture of ethylene carbonate and dimethyl carbonate. The volumetric ratio of ethylene carbonate to dimethyl carbonate in the organic solvent may be greater than or equal to about 2 to 8 to less than or equal to about 4 to 6. In aspects, the volumetric ratio of ethylene carbonate to dimethyl carbonate in the organic solvent may be about 3:7. The ethylene carbonate may constitute, by weight, greater than or equal to about 20% or optionally about 25% to less than or equal to about 40% or optionally about 35% of the electrolyte 28. In aspects, the ethylene carbonate may constitute, by weight, about 30% of the electrolyte 28. The dimethyl carbonate may constitute, by weight, greater than or equal to about 45% or optionally about 50% to less than or equal to about 70%, optionally about 65%, or optionally about 60% of the electrolyte 28. In aspects, the dimethyl carbonate may constitute, by weight, about 55% of the electrolyte 28.

The lithium salt is soluble in the organic solvent and provides a passage for lithium ions through the electrolyte 28. The lithium salt may comprise an inorganic lithium salt, an organic lithium salt, or a combination thereof. Examples of inorganic lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane) sulfonylimide (LIN(CF₃SO₂)₂), lithium bis(fluorosulfonyl) imide (LIN(FSO₂)₂) (LiSFI), and combinations thereof. Examples of inorganic lithium salts include lithium tetraphenylborate (LiB(C₆H₅)₄), lithium bis(oxalato) borate (LiB(C₂O₄)₂) (LiBOB), lithium difluorooxalatoborate (LiBF₂(C₂O₄)), and combinations thereof. The lithium salt may be dissolved in the organic solvent at a concentration of greater than or equal to about 0.5 Molar to less than or equal to about 1.5 Molar. In aspects, the lithium salt may be dissolved in the organic solvent at a concentration of about 1 Molar. The lithium salt may constitute, by weight, greater than or equal to about 5%, optionally about 8%, or optionally about 10% to less than or equal to about 20%, optionally about 15%, or optionally about 12% of the electrolyte 28. In aspects, the lithium salt may constitute, by weight, about 11% of the electrolyte 28. In aspects, the lithium salt may comprise LiPF₆.

The fluoroalkoxysilane additive is formulated to promote and/or participate in the formation of the first interphase layer 38 and/or the second interphase layer 42 during initial charge and/or cycling of the battery 20. The fluoroalkoxysilane additive is a chemical compound comprising a fluorinated organic group and one or more alkoxysilane groups. The fluoroalkoxysilane additive is a chemical compound having the following formula (1):

X—Si(—OR¹)₃₋ₐ(R²)^{a}, (1)

where X is a fluoroalkyl group or a fluoroaryl group, R¹ and R² are each individually an alkyl group, and a is 1 or 2. Alkyl groups have the formula —CₙH₂ₙ₊₁. Example alkyl groups include methyl groups (—CH₃) and ethyl groups (—CH₂CH₃). Fluoroalkyl groups are alkyl groups in which at least one of the hydrogen (H) atoms has been substituted with a fluorine (F) atom. In aspects, X may be a polyfluoroalkyl group in which two or more of the H atoms have been replaced with F atoms or a perfluoroalkyl group in which all of the H atoms have been replaced with F atoms. For example, X may be a polyfluoropropyl group, a polyfluorooctyl group, or a polyfluorodecyl group. An aryl group is a functional group or substituent derived from an aromatic ring, e.g., a phenyl group. Fluoroaryl groups are aryl groups in which at least one of the hydrogen (H) atoms has been substituted with a fluorine (F) atom. In aspects, X may be a polyfluoroaryl group in which two or more of the H atoms have been replaced with F atoms or a perfluoroaryl group in which all of the H atoms have been replaced with F atoms. For example, X may be a polyfluorophenyl group or a perfluorophenyl group (C₆F₅).

In aspects, the fluoroalkoxysilane additive may comprise a polyfluoroaryl alkoxysilane, e.g., a perfluorophenyl alkoxysilane. For example, the fluoroalkoxysilane additive may comprise triethoxy (perfluorophenyl) silane (TPS), CAS No. 20083-34-5.

In aspects, the fluoroalkoxysilane additive may comprise a polyfluoroalkyl alkoxysilane, e.g., a polyfluoropropyl alkoxysilane, a polyfluorobutyl alkoxysilane, a polyfluoropentyl alkoxysilane, a polyfluorohexyl alkoxysilane, a polyfluoroheptyl alkoxysilane, a polyfluorooctyl alkoxysilane, a polyfluorononyl alkoxysilane, or a polyfluorodecyl alkoxysilane. For example, the fluoroalkoxysilane additive may comprise trimethoxy (3,3,3-trifluoropropyl) silane (TTS, CAS No. 429-60-7), 1H, 1H,2H,2H-perfluorooctyltriethoxysilane (CAS No. 51851-37-7), 1H,1H,2H,2H-perfluorodecyltriethoxysilane (CAS No. 101947-16-4), 1H,1H,2H,2H-perfluorodecyltrimethoxysilane (CAS No. 83048-65-1), or dimethoxy(methyl) (3,3,3-trifluoropropyl) silane (CAS No. 358-67-8).

The fluoroalkoxysilane additive may constitute, by weight, greater than or equal to about 0.2%, optionally about 0.3%, optionally about 0.5% to less than or equal to about 1.8%, or optionally about 1.5% of the electrolyte 28. In aspects, the fluoroalkoxysilane additive may constitute, by weight, about 1% of the electrolyte 28.

The first interphase layer 38 and the second interphase layer 42 may inherently form in situ respectively on surfaces 40 of the negative electrode 22 and surfaces 44 of the positive electrode 24 during initial charge and/or cycling of the battery 20, for example, due to chemical reactions between the fluoroalkoxysilane additive in the electrolyte 28 and the electroactive materials of the negative and positive electrodes 22, 24. In FIG. 3, the first interphase layer 38 is depicted as being disposed along an interface between the negative electrode 22 and the separator 26 and the second interphase layer 42 is depicted as being disposed along an interface between the positive electrode 24 and the separator 26; however other arrangements are possible. For example, in aspects where the electroactive material of the negative and positive electrodes 22, 24 are in the form of particulate materials, the first interphase layer 38 may extend at least partway into the negative electrode 22 (toward the negative electrode current collector 30) and may be disposed on surfaces of one or more of the electroactive material particles of the negative electrode 22. Likewise, in aspects, the second interphase layer 42 may extend at least partway into the positive electrode 24 (toward the positive electrode current collector 32) and may be disposed on surfaces of one or more of the electroactive material particles of the positive electrode 24.

The first interphase layer 38 may inherently form in situ on surfaces 40 of the negative electrode 22 during initial charge and/or cycling of the battery 20 due to the electrochemical reduction of the fluoroalkoxysilane additive in the electrolyte 28 on surfaces 40 of the electroactive materials of the negative electrode 22. Without intending to be bound by theory, it is believed that the fluoroalkoxysilane additive may act as a sacrificial component of the electrolyte 28, thereby preventing degradation of the electrolyte 28 during charge and cycling of the battery 20. For example, it is believed that, due to the relatively low energy (more negative) of the lowest unoccupied molecular orbital (LUMO) of the fluoroalkoxysilane additive, the fluoroalkoxysilane additive may be preferentially reduced on surfaces 40 of the negative electrode 22 during initial charge and/or cycling of the battery 20, instead of the other components of the electrolyte 28 (e.g., the organic solvent and/or the lithium salt). For example, the LUMO energy of the fluoroalkoxysilane additive may be less than (more negative than) −0.25 electron volts (eV), or optionally less than or equal to about −0.3 eV. By contrast, other components of the electrolyte 28 may have higher (less negative) LUMO energies, e.g., ethylene carbonate =−0.21 eV, ethyl methyl carbonate =−0.2 eV, diethyl carbonate =−0.22 eV, and PF₆—=0.12 eV.

The second interphase layer 42 may inherently form in situ on surfaces 44 of the positive electrode 24 during initial charge and/or cycling of the battery 20 due to the electrochemical oxidation of the fluoroalkoxysilane additive in the electrolyte 28 on surfaces 44 of the electroactive materials of the positive electrode 24. Without intending to be bound by theory, it is believed that, due to the relatively high energy (less negative) of the highest occupied molecular orbital (HOMO) of the fluoroalkoxysilane additive, the fluoroalkoxysilane additive may be preferentially oxidized on surfaces 44 of the positive electrode 24 during initial charge and/or cycling of the battery 20, instead of the other components of the electrolyte 28. In turn, the preferential oxidation of the fluoroalkoxysilane additive, instead of the other components of the electrolyte 28, may allow the battery 20 to effectively and efficiently operate at a relatively high potential, as compared to electrochemical cells that do not include the fluoroalkoxysilane additive. For example, the HOMO energy of the fluoroalkoxysilane additive may be more than (less negative than) −8 (eV), or optionally more than or equal to about −7.88 eV. By contrast, other components of the electrolyte 28 may have lower (more negative) HOMO energies, e.g., ethylene carbonate =−8.73 eV, ethyl methyl carbonate =−8.4 eV, diethyl carbonate =−8.35 eV, and PF₆—=−10.01 eV.

The first interphase layer 38 and the second interphase layer 42 may respectively comprise the reaction products of the electrochemical reduction and the electrochemical oxidation of the fluoroalkoxysilane additive. Examples of such reduction and oxidation products include chemical compounds having silicon-oxygen bonds (Si—O bonds), silicon-fluorine bonds (Si—F bonds), silicon-carbon bonds (Si—C bonds), carbon-carbon bonds (C—C bonds), and/or carbon-hydrogen bonds (C—H bonds). In aspects, the first and second interphase layers 38, 42 may be hybrid organic-inorganic materials and may be made up of an interconnected network of nanosized organic components and nanosized inorganic components.

The first and second interphase layers 38, 42 may be electrically insulating and ionically conductive and may help prevent undesirable chemical reactions from occurring between the electrolyte 28 and the respective negative and positive electrodes 22, 24 after initial charging of the battery 20. For example, after the first and second interphase layers 38, 42 are formed respectively on surfaces 40, 44 of the negative and positive electrodes 22, 24, the first and second interphase layers 38, 42 may help prevent further chemical reactions from occurring between the components of the electrolyte 28 and the negative and positive electrodes 22, 24 during subsequent charge and/or discharge of the battery 20. Without intending to be bound by theory, it is believed that formation of the first and second interphase layers 38, 42 may help prevent undesirable chemical reactions from occurring between the electrolyte 28 and the respective negative and positive electrodes 22, 24, without impeding the flow of lithium ions between the electrolyte 28 and the negative and positive electrodes 22, 24. In addition, without intending to be bound by theory, it is believed that the Si atoms in the first and second interphase layers 38, 42 may react with and scavenge undesirable hydrogen fluoride (HF) and/or fluorine ions (F—) in the electrolyte 28, which may help stabilize the electroactive material of the positive electrode 24, for example, by preventing degradation of the positive electrode 24 caused by transition metal ion dissolution therefrom.

The optional one or more carbonate additives may be formulated to assist in the formation and stabilization of the first interphase layer 38 and/or the second interphase layer 42 during initial charge and/or cycling of the battery 20. In aspects, the one or more carbonate additives may comprise fluoroethylene carbonate (FEC), vinylene carbonate (VC), or a combination thereof. The fluoroethylene carbonate may constitute, by weight, greater than or equal to about 1% to less than or equal to about 3% of the electrolyte 28. In aspects, the fluoroethylene carbonate may constitute, by weight, about 2% of the electrolyte 28. The vinylene carbonate may constitute, by weight, greater than or equal to about 0.5% to less than or equal to about 1.5% of the electrolyte 28. In aspects, the vinylene carbonate may constitute, by weight, about 1% of the electrolyte 28.

Cyclic voltammetry testing was on electrochemical cells including different electrolyte formulations. All electrochemical cells included a negative electrode consisting of: an electroactive material consisting of a mixture of graphite and 5.5 wt. % silicon oxide (SiOx, where 0<x<2), electrically conductive particles of CB, and a CMC/SBR polymer binder. All electrochemical cells included a positive electrode consisting of: an electroactive material consisting of NCMA, electrically conductive particles of CNT, CB, and GNP, and a PVDF polymer binder having a theoretical capacity of about 5 milliampere hours per square centimeter (mAh/cm²). All electrochemical cells included a control electrolyte composition consisting of: 1 Molar LiPF₆ in a mixture of EC and DMC (EC:DMC=3:7 vol/vol). Electrochemical cells including an electrolyte that included, in addition to the control electrolyte composition, 1 wt. % TPS or 1 wt. % TTS exhibited higher discharge capacities and higher capacity retention than electrochemical cells including the control electrolyte composition alone.

The positive and negative electrode current collectors 30, 32 are electrically conductive and provide an electrical connection between the external circuit 36 and their respective positive and negative electrodes 22, 24. In aspects, the positive and negative electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a positive electrode;
a negative electrode comprising a silicon-containing electroactive active material; and
an electrolyte infiltrating the positive electrode and the negative electrode, the electrolyte comprising:
an organic solvent;
an inorganic lithium salt in the organic solvent; and
a fluoroalkoxysilane additive in the organic solvent.

2. The battery of claim 1, wherein the fluoroalkoxysilane additive comprises a chemical compound having the following formula: X—Si(—OR¹)₃₋ₐ(R²)ₐ, where X is a fluoroalkyl group or a fluoroaryl group, R¹ and R² are each individually an alkyl group, and a is 1 or 2.

3. The battery of claim 1, wherein the fluoroalkoxysilane additive comprises a polyfluoroaryl alkoxysilane, a polyfluoroalkyl alkoxysilane, or a combination thereof.

4. The battery of claim 1, wherein the fluoroalkoxysilane additive comprises triethoxy (perfluorophenyl) silane, trimethoxy (3,3,3-trifluoropropyl) silane, 1H, 1H,2H,2H-perfluorooctyltriethoxysilane, 1H, 1H,2H,2H-perfluorodecyltriethoxysilane, 1H, 1H,2H,2H-perfluorodecyltrimethoxysilane, dimethoxy(methyl) (3,3,3-trifluoropropyl) silane, or a combination thereof.

5. The battery of claim 1, wherein the fluoroalkoxysilane additive has a lowest unoccupied molecular orbital (LUMO) of less than (more negative than) −0.25 electron volts and a highest occupied molecular orbital (HOMO) energy of more than (less negative than) −8 electron volts.

6. The battery of claim 1, wherein the fluoroalkoxysilane additive constitutes, by weight, greater than or equal to about 0.2% to less than or equal to about 1.8% of the electrolyte.

7. The battery of claim 1, wherein, during cycling of the battery, the fluoroalkoxysilane additive decomposes and forms an interphase layer on surfaces of the silicon-containing electroactive active material of the negative electrode that isolates the silicon-containing electroactive active material from physical contact with the electrolyte.

8. The battery of claim 1, further comprising:
an interphase layer formed in situ on the silicon-containing electroactive active material of the negative electrode during cycling of the battery,
wherein the interphase layer comprises a hybrid organic-inorganic material and physically isolates the silicon-containing electroactive active material from contact with the electrolyte.

9. The battery of claim 1, wherein the organic solvent comprises ethylene carbonate and dimethyl carbonate.

10. The battery of claim 1, wherein the inorganic lithium salt comprises lithium hexafluorophosphate.

11. A battery that cycles lithium ions, the battery comprising:
a positive electrode comprising a nickel-based electroactive material;
a negative electrode comprising a silicon-containing electroactive active material; and
an electrolyte infiltrating the positive electrode and the negative electrode, the electrolyte comprising:
an organic solvent;
an inorganic lithium salt in the organic solvent; and
a fluoroalkoxysilane additive in the organic solvent, the fluoroalkoxysilane additive comprising a chemical compound having the following formula: X—Si(—OR¹)₃₋ₐ(R²)^{a}, where X is a fluoroalkyl group or a fluoroaryl group, R¹ and R² are each individually an alkyl group, and a is 1 or 2.

12. The battery of claim 11, wherein the fluoroalkoxysilane additive comprises triethoxy (perfluorophenyl) silane, trimethoxy (3,3,3-trifluoropropyl) silane, 1H, 1H,2H,2H-perfluorooctyltriethoxysilane, 1H, 1H,2H,2H-perfluorodecyltriethoxysilane, 1H, 1H,2H,2H-perfluorodecyltrimethoxysilane, dimethoxy(methyl) (3,3,3-trifluoropropyl) silane, or a combination thereof.

13. The battery of claim 11, wherein the fluoroalkoxysilane additive constitutes, by weight, greater than or equal to about 0.2% to less than or equal to about 1.5% of the electrolyte.

14. The battery of claim 11, further comprising:
a first interphase layer disposed on the nickel-based electroactive material of the positive electrode that physically isolates the nickel-based electroactive material from contact with the electrolyte; and
a second interphase layer disposed on the silicon-containing electroactive active material of the negative electrode that physically isolates the silicon-containing electroactive active material from contact with the electrolyte,
wherein the first interphase layer and the second interphase layer are formed in situ during cycling of the battery, and
wherein the first interphase layer and the second interphase layer comprise decomposition products of the fluoroalkoxysilane additive.

15. The battery of claim 14, wherein electrochemical oxidation of the fluoroalkoxysilane additive occurs at the positive electrode during charge of the battery, and wherein the first interphase layer comprises byproducts of the electrochemical oxidation of the fluoroalkoxysilane additive.

16. The battery of claim 14, wherein electrochemical reduction of the fluoroalkoxysilane additive occurs at the negative electrode during charge of the battery, and wherein the second interphase layer comprises byproducts of the electrochemical reduction of the fluoroalkoxysilane additive.

17. The battery of claim 14, wherein the first interphase layer and the second interphase layer each comprise a hybrid organic-inorganic material.

18. The battery of claim 14, wherein the first interphase layer and the second interphase layer each comprise a chemical compound including silicon-oxygen bonds, silicon-carbon bonds, carbon-carbon bonds, carbon-hydrogen bonds, or a combination thereof.

19. The battery of claim 11, wherein the organic solvent comprises ethylene carbonate and dimethyl carbonate, and wherein the inorganic lithium salt comprises lithium hexafluorophosphate.

20. The battery of claim 11, wherein the nickel-based electroactive material comprises lithium nickel cobalt manganese aluminum oxide, lithium nickel manganese cobalt oxide, lithium nickel cobalt aluminum oxide, or a combination thereof, and wherein the silicon-based electroactive material comprises silicon, silicon oxide, lithium silicon oxide, or a combination thereof.
